(19) United States
(12) Patent Application Publication
(10) Pub. No.: US 2015/0336461 A1
(43) Pub. Date: Nov. 26, 2015

(54) ELECTRICAL NETWORK FOR AUTOMOTIVE VEHICLE

(71) Applicant: Valeo Systemes de Controle Moteur, Cregy Saint Christophe (FR)

(72) Inventors: Sylvain Decoster, Fontenay Le Fleury (FR); Cyrille Corniglion, Ermont (FR); Antoine Richert, Paris (FR); Daniel Benchetrite, Creteil (FR); Philippe Baudesson, La Boissiere (FR); Mehdi Banasse, Maisons-Alfort (FR)

(73) Assignee: Valeo Systemes de Controle Moteur, Cergy Saint Christophe (FR)

(21) Appl. No.: 14/433,253

(22) PCT Filed: Oct. 3, 2013
(86) PCT No.: PCT/FR2013/052354

§ 371 Date: Aug. 4, 2015

(30) Foreign Application Priority Data
Oct. 3, 2012 (FR) 1259378

(51) Int. Cl. B60L 11/18; B60L 11/02

(52) U.S. Cl. CPC B60L 11/18; B60L 11/02

(57) ABSTRACT

The invention relates to an electrical network (1) for automotive vehicle comprising: —a first electrical subnetwork (2), said first electrical subnetwork (2) comprising in parallel an electrical generator (21), a first energy store (22), at least one first electrical consumer (23); a second electrical subnetwork (3), said second electrical subnetwork (3) comprising in parallel a second energy store (31), a second electrical consumer (32), a third electrical consumer (33); a DC/DC converter (4), configured to charge the second energy store (31) from the first subnetwork. The electrical network (1) furthermore comprises: a means of switching (5) between the first subnetwork (2) and the second subnetwork (3), said switching means (5) being configured to electrically link the first subnetwork (2) and the second subnetwork (3) when the voltage across the terminals of the second energy store (31) becomes equal to the voltage across the terminals of the first energy store (22), so as to ensure a supplying of the second consumer (32) by the electrical generator (21) —a second switching means (6) configured to selectively isolate and connect the third electrical consumer (33) with the second energy store (31) and the second electrical consumer (32); a third electrical consumer (33) having one same terminal in common with the first switching means (5) and the second switching means (6).

The invention relates to an electrical network for an automotive vehicle comprising at least one high-power component transiently activating itself. More particularly, the invention concerns an electrical network furthermore comprising an electrical generator, an energy store which stores the electrical energy generated by the said generator and an energy consumer device of the vehicle, hereinafter called an “electrical consumer” ensuring, for example, functions of ventilation and lighting.

In the context of this application, a high-power component means an electrical consumer requiring an electrical power greater than that of the energy consumer device. In particular, the high-power component may transiently require a large amount of electrical energy, for example when it is activated. For example, the high-power consumer may comprise any power component that consumes high current, in the order of 400-500 A, for a limited duration, between 0 and 10 s (during the transient activation period of the component).

In the context of this application, power store means any energy store having a high power density. For example, a power store is an energy store whose P/E (Power/Energy) ratio is greater than a pre-defined value, for example P/E>20.

On activation of the high-power component, a high current draw is transiently produced on the electrical network of the vehicle. The intensity of the drawn current depends on the desired response time required by this high-power component for its activation. As an example, on activation of an electrical supercharger, the speed of rotation of the turbine of said supercharger must rise from 4000 RPM to 70000 RPM in 350 ms. The power required on activation may be between 1 and 7 kW. Thus, such a component requires considerable electrical power at the time of its activation. Now, a drop in the component's performance, in order to avoid high current draw, is undesirable. The energy required during the start-up phase of such a power component is provided by the energy store and not by the generator because the generator's response time is usually longer than that of the high-power component. However, the energy store of a vehicle electrical network is limited in voltage. For a vehicle battery, the battery voltage is preferably around 12 V. This voltage is insufficient for optimum assurance of both the activation of the high-power component and the supply of the other energy consumers.

In fact, the activation of a high-power component causes a drop in voltage on the electrical network which can lead to outages or malfunctions of other consumer devices of the vehicle. These consumer devices, which operate at a voltage higher than a minimum voltage threshold, may be vehicle safety or comfort components, for example the vehicle's headlights. Their operation must be ensured at all times for the safety of the vehicle's passengers.

Furthermore, since the high-power component is supplied by the energy store of the vehicle network, the lifetime of the energy store is reduced by the high current draws that it must undergo on activation of the high-power component. A more powerful battery would therefore need to be installed on the on-board network, but that would involve high costs.

### DESCRIPTION OF THE INVENTION

The invention aims to remedy all or some of the above drawbacks and notably to propose a cheaper electrical network for an automotive vehicle which is protected against voltage drops on activation of high-power components without degrading the performance of the network energy store or its lifetime.

Consequently, one aspect of the invention relates to an electrical network for an automotive vehicle comprising:
a first electrical network, the said first electrical network comprising in parallel:
   an electrical generator;
   a first energy store;
   at least one electrical consumer;
a second electrical network, the said second electrical network comprising in parallel:
   a second electrical store;
   a second electrical consumer;
   a DC/DC converter, configured to charge the second energy store from the first subnetwork;

characterised in that the electrical network furthermore comprises a means of switching between the first subnetwork and the second subnetwork, the said switching means being configured to electrically connect the first subnetwork and the second subnetwork when the voltage across the terminals of the second energy store becomes equal to the voltage across the terminals of the first energy store, so as to ensure a supplying of the second consumer by the electrical generator.

The network therefore comprises a first electrical subnetwork, intended for the vehicle's first electrical energy consumer, also called the electrical charge of the vehicle, requiring a voltage stabilised and supplied by the energy store or by the electrical generator. The network also comprises a second electrical subnetwork intended for the second consumer. The second consumer is in particular a component that causes drops in voltage, for example a high-power component activating itself transiently. The first subnetwork is isolated from the second subnetwork by the DC/DC converter of the electrical network. The energy store of the second subnetwork is charged by the electrical generator or the energy store of the first subnetwork by means of the DC/DC converter. The second energy store can thus supply the second component with sufficient voltage on the activation thereof. In particular, the DC/DC converter amplifies the voltage that it encounters at the input, i.e. the voltage of the first electrical subnetwork. In the case of a standard vehicle, the voltage of the first electrical subnetwork is around 12 V. The second energy store is sized on the basis of the second component arranged in the second electrical subnetwork. As the first subnetwork is isolated from the second subnetwork by the DC/DC converter, it is not affected by the voltage drops that occur on activation of the second component.

In particular, the first energy store is configured to supply the first electrical consumer. In particular, the second energy store is configured to supply the second electrical consumer.

For example, the first electrical subnetwork is linked to the input of the DC/DC converter and the second electrical subnetwork is linked to the output of the DC/DC converter.

In particular, the switching means connect the input of the DC/DC converter to the output of the DC/DC converter. The switching means allow the supply to be changed over from the second component to the first subnetwork, and thus to the electrical generator, if the activation of the second component is long or if the second energy store discharges too quickly i.e. when the energy required for the activation of the second component is greater than the energy that can be used in the second energy store. Thus the electrical generator can take over and ensure the supply of power for the rest of the activation phase of the second component. The changeover of power from the second component to the first subnetwork is achieved by closing the switching means. The closure of said switching means can be achieved by control means that are, for example, controlled by a sensor of the voltage across the terminals of the energy store of the second subnetwork.

In addition to the main characteristics just mentioned in the preceding paragraph, the electrical network according to the invention can have one or more complementary characteristics among those listed below, considered individually or in accordance with technically possible combinations:
the second energy store has a greater storage capacity than that of the first energy store and the second electrical consumer has a greater electrical power than that of the first electrical consumer;
in particular, the second component is a high-power component, notably an electrical supercharger;
the second energy store is a power store, in particular a super-condenser. A super-condenser is a power store particularly well adapted to supply high power during a limited amount of time. Furthermore, a super-condenser has the advantage of being capable of withstanding an unlimited number of charge/discharge cycles, unlike a battery type energy store present on the electrical network of an automotive vehicle. In particular, the number of condensers and their characteristics are dimensioned on the basis of the power required to activate the component of the second electrical subnetwork. The charge of a super-condenser also has the advantage of being rapid, which allows the activation phases of the second component to follow one after the other within a limited amount of time, particularly in the case of a high-power component. The charging time can depend on the capacity of the super-condenser, the recharging current and the difference in Vmax/Vmin voltage. For example, for a current of 300 A, it takes around 20 s to charge a 2000 F-cell from 0 to 2.7 V (2.7 V being the maximum voltage of the cell);
the second electrical subnetwork comprises an electrical connection in parallel comprising a third electrical consumer. The second electrical subnetwork can be intended for a plurality of consumers of an electrical network of an automotive vehicle causing voltage drop during their activation and possibly disturbing the first electrical subnetwork;
the second electrical subnetwork comprises a second switching means configured so as to selectively isolate and connect the parallel connection to the second energy store and the second electrical consumer;
the first switching means is connected to the second subnetwork by means of a terminal of the said parallel connection;
the third component is a starter. The arrangement of a starter in parallel in the second electrical subnetwork prevents, on starting the vehicle, the appearance of voltage drops on the on-board network, particularly the first subnetwork.
In this case, the super-condenser is preferably dimensioned to be able to compensate for the drop in voltage on activation of the high-power component that has the greatest voltage drop on starting;
the DC/DC converter is step-up/step-down converter (known as a buck-boost converter). A DC/DC buck-boost converter allows the second energy store to be charged, from the input voltage of the said converter, i.e. the voltage of the first subnetwork, in two stages:
   in a first stage, when the voltage across the terminals of the second energy store is zero or below that of the first subnetwork, the DC/DC converter is commanded by the command means to play a voltage step-down role (buck) so that the output voltage is between 0 and the voltage of the first subnetwork;
   in a second stage, when the voltage across the terminals of the power store is equal to the voltage of the first electrical subnetwork, the DC/DC converter is commanded by the command means to play a voltage step-up role (boost) so that the output voltage is voltage. This maximum voltage is determined so as to ensure the activation of the second component;
   and
the electrical generator is an alternator connected in parallel to an AC/DC converter.

The invention also concerns a method of managing the supply of the components of an electrical network for an automotive vehicle, the said network comprising a first electrical subnetwork, the said first electrical subnetwork comprising in parallel:
an electrical generator;
a first energy store;
at least one first electrical consumer;
a second electrical subnetwork, the said second electrical subnetwork comprising in parallel:
a second energy store;
a second electrical consumer;
a DC/DC converter configured to charge the second energy store from the first subnetwork when the second electrical consumer is off; and
a switching means between the first subnetwork and the second subnetwork,

characterised in that the said method comprises a step of closing the switching means to electrically connect the first subnetwork and the second subnetwork when the voltage across the terminals of the second energy store is equal to the voltage across the terminals of the first energy store, so as to ensure a supply to the second consumer by the electrical generator.

According to one of its aspects, the invention also concerns an electrical network for an automotive vehicle comprising:
a first electrical subnetwork, the said first electrical subnetwork comprising in parallel:
   an electrical generator;
   a first energy store;
   at least one first electrical consumer;
a second electrical subnetwork (3), the said second electrical subnetwork comprising in parallel:
   a second energy store;
   a second electrical consumer;
   a third electrical consumer;
a DC/DC converter, configured to charge the second energy store from the first subnetwork;
   The electrical network also comprising:
a means to switch between the first subnetwork and the second subnetwork, the said switching means being configured to electrically connect the first subnetwork and the second subnetwork when the voltage across the terminals of the second energy store becomes equal to the voltage across the terminals of the first energy store, so as to ensure a supply to the second consumer by the electrical generator;
a second switching means configured to selectively isolate and connect the third electrical consumer with the second energy store and the second electrical consumer;
   the third electrical consumer having one terminal in common with the first switching means and the second switching means.

In other words, in this aspect of the invention, the third component has one terminal in common with the first switch. This same terminal of the third component is also in common with the second switch. In particular, the third component has a connected terminal to ground the network, and another terminal connected at one end to a terminal of the first switching means and at the other end to a terminal of the second switching means.

Thus, in this aspect of the invention, the electrical connection comprising the third electrical consumer is located between the first switching means and the second switching means. This third consumer can therefore be supplied by the first subnetwork and/or by the second subnetwork, regardless of the other electrical consumers.

The network according to this aspect of the invention can have one or more of the above-described characteristics that are compatible with it.

In a variation, the DC/DC converter can be a reversible converter. In other words, the converter can not only allow a transmission of an electrical signal from the first subnetwork to the second subnetwork, but also a transmission of an electrical signal from the second subnetwork 3 to the first subnetwork. Thus, the second store can advantageously supply the first subnetwork when the second store has a sufficient charge.

For example, the power store can be charged during a regenerative braking phase. The electrical generator then produces electrical energy from a mechanical braking of the vehicle. All or part of this energy is transmitted to the second store. Afterwards, the energy stored in the second energy store can be used to supply the second consumer and/or to supply the first subnetwork by means of the reversible DC/DC converter.

### BRIEF DESCRIPTION OF THE FIGURES

Further features and advantages of the invention will emerge from the following description, with reference to the accompanying drawings, in which:

FIG. 1 is a diagram of an electrical network according to a first embodiment of the invention;

FIG. 2 is a diagram of an electrical network according to a second embodiment of the invention;

FIG. 3 is a diagram of an electrical network according to a third embodiment of the invention.

For the sake of clarity, identical or similar elements bear the same reference numerals in all of the Figures.

### DETAILED DESCRIPTION OF AN EMBODIMENT

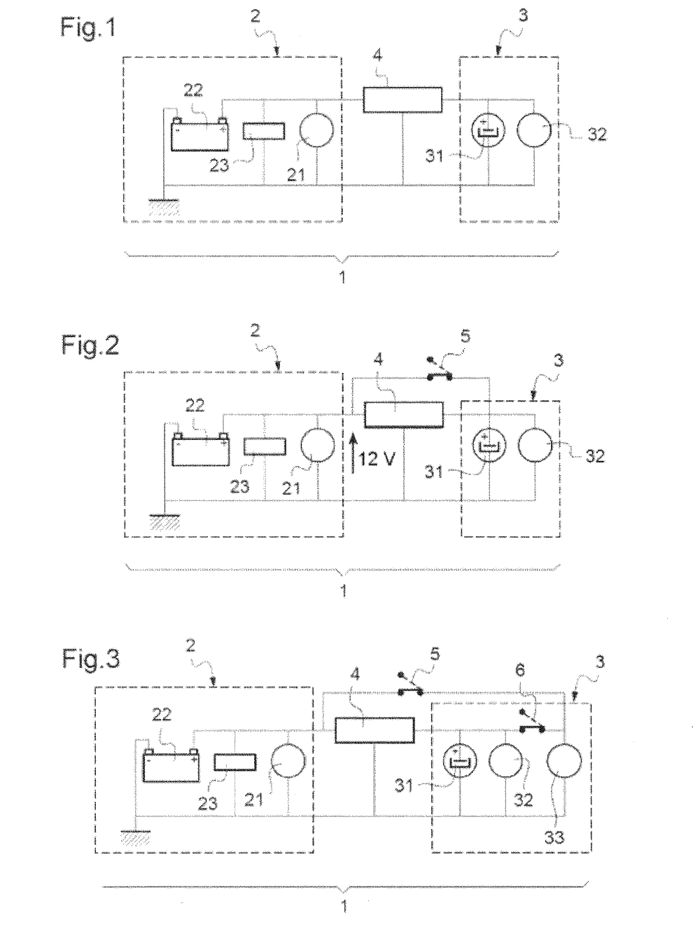

FIG. 1 shows a diagram of an electrical network 1 for an automotive vehicle. This electrical network 1 comprises a first electrical subnetwork 2 comprising an energy store, here a battery 22, connected in parallel to an electrical generator 21 and to an electrical consumer 23. The electrical consumer 23 is a consumer device of the vehicle, for example a device for ventilation or lighting. There may be several electrical consumers on the first electrical subnetwork 2. This electrical consumer requires a stabilised voltage that does not fall below an operating threshold. Note that for some consumers, a voltage that is below the operating threshold for a very short period can be withstood. For example, a drop in voltage for a few microseconds would not be visible, even in a lighting system. The electrical network 1 comprises a second electrical subnetwork 3 comprising a power store, here a super-condenser 31, connected in parallel to a high-power component that activates itself transiently, here an electrical supercharger 32. The power store 31 is, in this embodiment, a super-condenser but could also be of a lithium store type. The electrical network 1 comprises a DC/DC converter 4. The first electrical subnetwork 2 is connected to the input of the DC/DC converter 4 and the second electrical subnetwork 3 is connected to the output of the DC/DC converter 4. The first electrical subnetwork 2 shown is an on-board network of a vehicle operating at a voltage of around 12 V. During its transient activation phase, the electrical supercharger 32 has high current draws which have no effect on the electrical consumer 23 of the first electrical subnetwork 2. In fact, the supercharger 32 is isolated from the first electrical subnetwork 2 by the DC/DC converter 4 and the current draw during the activation of the electrical supercharger 32 will not result in a voltage drop in the first subnetwork 2. This voltage drop is visible only by the power store 31 of the second electrical subnetwork 3. The lifetime of the battery 22 is not affected by these current draws.

The battery 22 is charged in a known way by the electrical generator 21. Once the battery 22 is charged by the electrical generator, control means can ensure that the electrical generator 21 supplies only the electrical consumer 23. The said control means can be connected to a means to measure the current of the battery 22 (not shown in the Figures) which can be arranged on one of the positive or negative terminals of the battery 22, allowing the state of charge of the battery 22 to be detected. Once the battery 22 is in its optimum state, the generator 21 supplies only the electrical consumer 23 of the vehicle by means of a “zero battery current” voltage regulator allowing an overall zero current to be obtained at the battery 22.

The DC/DC converter 4 takes the energy in the first subnetwork 2 to charge the super-condenser 31. In the embodiment shown in FIG. 1, the DC/DC converter is a buck-boost voltage converter. Thus the output voltage of the converter 4 can be:
between 0 and the value of the voltage across the terminals of the first electrical subnetwork 2 during a phase when the converter 4 acts as a step-down converter, its input voltage being the voltage across the terminals of the first electrical subnetwork 2;
between the value of the voltage across the terminals of the first electrical subnetwork 2 and a pre-set maximum value allowing a sufficient power supply of the supercharger 32 to be ensured during the activation phase of the said supercharger. During this phase, the converter 4 acts as a step-up converter, its input voltage being the voltage across the terminals of the first electrical subnetwork 2.

Thus, the voltage across the terminals of the super-condenser 31 varies between, firstly, a zero voltage and the voltage across the terminals of the battery 22, then between the voltage across the terminals of the battery 22 and the maximum voltage that the super-condenser 31 can withstand. This maximum voltage that the super-condenser 31 can withstand depends on the response time required of the electrical supercharger 32, this response time dimensioning the intensity and duration of the current draw during activation.

During activation of the supercharger 32, command means allow the super-condenser 31 to supply the supercharger 32 with sufficient voltage. The super-condenser 31 discharges in the supercharger 32. Thus, only the second electrical subnetwork 3 is disturbed by the activation of the high-power component 32. The super-condenser 31, once discharged, is recharged by the DC/DC converter 4 in order to be able to respond to a new demand from the electrical supercharger 32.

FIG. 2 shows schematically another electrical network 1 for an automotive vehicle. The electrical network 1 of FIG. 2 differs from that shown in FIG. 1 by the addition of a switching means 5 between the input of the DC/DC converter 4 and the output of the DC/DC converter 4. The switching means 5 used can, for example, be a mechanical relay dimensioned on the basis of the maximum current and the number of activations envisaged.

Control means in particular cause the switching means to change over between an on-state and an off-state. In its off-state, the operation of the electrical circuit is identical to that previously described with reference to FIG. 1. The changeover into the on-state can be made by the control means when the voltage across the terminals of the super-condenser 31 is no longer sufficient to supply the supercharger 32 and the activation phase has not yet finished. In particular, the voltage across the terminals of the super-condenser 31 is no longer sufficient when the voltage across the terminals of the super-condenser 31 is no longer greater than the voltage across the terminals of the first subnetwork 2, in particular across the terminals of the first store 22. This instance corresponds for example to the case where the super-condenser 31 has not stored sufficient power during its charging to meet the needs of the supercharger 32. The high-power component 32, here an electrical supercharger 32, can then be supplied with power by the electrical generator 21 of the first subnetwork. In other words, the power demanded by the high-power component 32 during its activation can be provided if necessary by the electrical generator 21.

This lack of power of the store 31 of the second subnetwork may be the result of the transient activation phase of the supercharger 32 lasting too long or an insufficient charging of the super-condenser 31. In these cases, the switching means 5 change over to the on-state and short-circuit the DC/DC converter 4. The supercharger 32 is supplied by the electrical generator 21 of the first subnetwork 2 or possibly by the battery 22.

Note that when the operation of the supercharger 32 is prolonged, it is then at a stabilised speed, for example at 70000 RPM. The power required by the supercharger 32 is then less than that required during its activation. When the switching means 5 change to the on-state, the supercharger 32 does not therefore cause a drop in voltage on the first subnetwork 2.

FIG. 3 shows schematically another electrical network 1 for an automotive vehicle. The electrical network 1 of FIG. 3 differs from that shown in FIG. 2 by the addition of a starter 33 connected in parallel to the second subnetwork 3 and a switch 6 between one terminal of the starter 33 and the other elements 31, 32 of the second subnetwork 3. The first switch 5 is connected to the second subnetwork 3 by means of this same terminal of the starter 33. This embodiment describes the connection of a starter 33 in parallel to the second electrical subnetwork, but applies to any high-power component that activates itself transiently whose activation could disturb the operation of the energy consumers 23 of the vehicle's first electrical subnetwork 2.

The second switch 6 allows the operating modes of the second subnetwork 3 to be varied. The supercharger 32 and the starter 33 can be isolated from the first subnetwork 2 (the first switch 5 is open) and supplied by the super-condenser 31 (the second switch 6 is closed). Thus, on starting the vehicle, the starter 33 whose activation could disturb the operation of the electrical consumer 23 due to the current draw created, is isolated from the first subnetwork 2 and the super-condenser 31 ensures its supply. The supercharger 32 and the starter 33 can both be supplied by the same subnetwork 2 (the first and second switches 5, 6 are closed). Alternatively, the supercharger 32 is supplied by the super-condenser 31 while the starter 33 is supplied by the first subnetwork 2 (first switch 5 closed and second switch 6 open).

Clearly, the invention is not limited to the examples described. In particular, the supercharger 32 and the starter 33 can be other high-power components.

1. A electrical network for an automotive vehicle comprising:
a first electrical subnetwork, the said first electrical subnetwork comprising in parallel:
an electrical generator,
a first energy store, and
at least one first electrical consumer;
a second electrical subnetwork, the said second electrical subnetwork comprising in parallel:
a second energy store,
a second electrical consumer,
a third electrical consumer, and
a DC/DC converter, configured to charge the second energy store from the first subnetwork;
a means to switch between the first subnetwork and the second subnetwork, the switching means being configured to electrically connect the first subnetwork and the second subnetwork when the voltage across the terminals of the second energy store becomes equal to the voltage across the terminals of the first energy store, so as to ensure a supply to the second consumer by the electrical generator; and
a second switching means configured to selectively isolate and connect the third electrical consumer with the second energy store and the second electrical consumer;
the third electrical consumer having one terminal in common with the first switching means and the second switching means.

2. The electrical network according to claim 1, wherein the second energy store has a greater storage capacity than that of the first energy store and the second electrical consumer has a greater electrical power than that of the first electrical consumer.

3. The electrical network according to claim 1, wherein the third component is a starter.

4. The electrical network according to claim 1, wherein the energy store is a super-condenser.

5. The electrical network according to claim 1, wherein the second consumer is an electrical supercharger.

6. The electrical network according to claim 1, wherein the DC/DC converter is a step-up/step-down converter.

7. The electrical network according to claim 1, wherein the DC/DC converter is a reversible converter.

8. The electrical network according to claim 1, wherein the electrical generator is an alternator connected in parallel to an AC/DC converter.
